(19) United States
(12) Patent Application Publication
(10) Pub. No.: US 2009/0325717 A1
(43) Pub. Date: Dec. 31, 2009

(54) Video Game Controller Holder

(76) Inventor: Marlon John Lee-Him, Calgary (CA)

Correspondence Address: Maxey Law Offices, PLLC, 13630 58TH ST. NORTH, SUITE 101, CLEARWATER, FL, 33760, US

(21) Appl. No.: 12/146,686

(22) Filed: Jun. 26, 2008

(51) Int. Cl. A63F 13/02

(52) U.S. Cl. 463/47; 273/148 B

(57) ABSTRACT

A video game controller holder for storing the controller when not being used is provided with a customizable appearance to a user's preference. The holder includes a cradle body with a controller support surface that contoured to compliment the controller permitting the controller to be placed on the support surface. The cradle body includes a display surface to which is mountable a display. The display may provide decorative indicia to the holder, which may be selected by the user to his or her individual preferences. The display may be removably mounted permitting a user to change the display as desired. The display may be a static display, such as an ornamental plaque, or may be a changeable electronic display, such as a liquid crystal display (LCD). The electronic display may be pre-programmed with various images or visual effects that are selectable by the user. Alternatively, the electronic display may be operatively connectable to a remote computer or video game console by any data link to display various information provided to the display by the remote computer or video game console.

### FIELD OF THE INVENTION

The present invention relates generally to video game accessories, and more particularly, relating to a holder for a video game controller when the controller is not being used.

### BACKGROUND OF THE INVENTION

Video game controllers, wired or wireless, are used to play various video games using a video game console or a personal computer. When the video games are not being played, the video game controllers are typically tossed to the side until the next game session. There exist video game controller holding devices which aim to provide organization of the video game controllers when not being used. However, the devices heretofore, do not provide the user with the ability to customize the decorative appearance of the devices to suite their personal desires or do not provide interaction with the video game console or computer system used to play the video games.

Accordingly, there is a need for a new video game controller holder that has a decorative appearance that is customizable to the preference of the user, and for a new video game controller holder that interacts with a video game console or computer system to provide an enhanced gaming experience.

### SUMMARY OF THE INVENTION

The preferred embodiments of the present invention addresses this need by providing a video game controller holder having an area that is customizable to a particular user's preference, and by providing a video game controller holder that is interactive with a video game console or computer system.

It is an object of the present invention is to provide a video game controller holder for storing a controller when it is not in use.

Another object of the present invention is to provide a video game controller holder having an appearance that is customizable to a user's preference.

Another object of the present invention is to provide a video game controller holder having an illuminated decorative display.

Another object of the present invention is to provide a video game controller holder having an electronic display for displaying various information and/or images.

Another object of the present invention is to provide a video game controller holder having an electronic display that is communicable with a video game console or computer which a video game controller is used to display various information on the electronic display.

To achieve these and other advantages, in general, in one aspect, holder for a video game controller is provided. The holder includes a cradle body defining an upwardly facing video game controller support surface for receiving and holding a video game controller thereon, a display surface, and a display attached to said display surface.

In general, in another aspect, the holder further includes a light source, a power source connected to the light source and operable to provide power to the light source to cause the light source to illuminate, the display including at least one light transmissive portion, and the light source being positioned to transmit light through the at least one light transmissive portion.

In general, in another aspect, the video game controller support surface includes a central recessed portion and, a pair of support surfaces along opposite sides of the central recessed portion that are contoured to compliment the exterior surface of a video game controller so as to receive and support a video game controller thereon.

In general, in another aspect, the holder further includes a power source, the display is an electronic display, and the power source is connected to the electronic display to provide power thereto.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The accompanying drawings, which are included to provide further understanding of the invention and are incorporated in and constitute a part of this specification, illustrate preferred embodiments of the invention and together with the description serve to explain the principles of the invention, in which:

FIG. 1 is a front perspective view of the video game controller holder constructed in accordance with the principles of the present invention;

FIG. 2 is a side elevation view of the holder of FIG. 1;

FIG. 3 is a rear perspective view of the holder of FIG. 1;

FIG. 4 is a longitudinal cross-sectional view of the holder of FIG. 1;

FIG. 5 is a front perspective view of an alternate embodiment of the video game controller holder of FIG. 1 incorporating a digital display; and

FIG. 6 is a diagrammatic view of an example wireless communication link between the digital display and a remote computer or video game console.

### DETAILED DESCRIPTION OF THE INVENTION

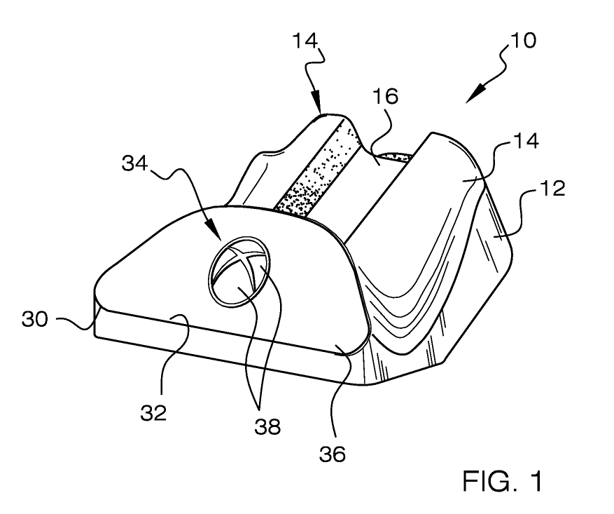

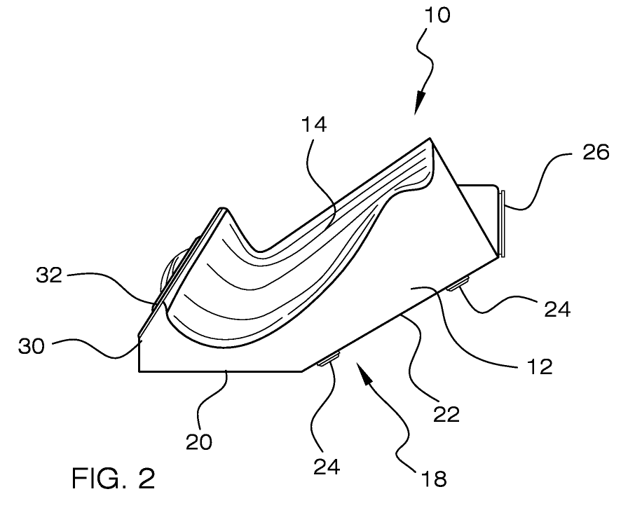

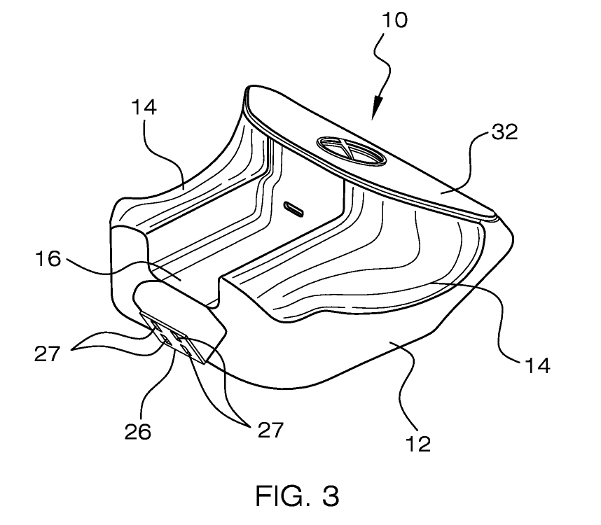

In FIGS. 1-3, a holder 10 for a video game controller is illustrated. The holder 10 includes a cradle body 12 on to which a video game controller (not shown) can be placed for storage when the video game controller is not being used. The body 12 may be monolithically formed with a suitable material, such as, for example, plastic or wood. The cradle body 12 includes an upwardly facing video game controller support surface 14 on to which a video game controller can be placed. The support surface 14 is contoured to compliment the external surfaces of a video game controller which is to be placed on the cradle body 12. The support surface 14 may include a longitudinal recessed central portion 16 to accommodate various video game controllers that have battery packs or other structural aspects extending outward from the back side thereof so as to permit the video game controller to rest upon the support surface. The central portion 16 divides the support surface 14 into a pair of longitudinal and contiguous support surfaces positioned along opposite sides of the central portion.

The cradle body 12 includes a bottom surface 18 for supporting the cradle body upon a table top or the like. The bottom surface 18 includes a forward planer portion 20 and a rearward planer portion 22 angled relative to the forward portion providing two separate surfaces on which the cradle may be supported to adjust the angle of the support surface 14 relative to horizontal. Feet 24 may be attached to both or either of the forward and rearward portions 20 and 22.

A rearward surface 26 of the cradle body 12 includes one or more apertures 27 for receiving the head portion of a fastener, such as a nail or screw, to permit mounting of the holder 10 to a wall surface, as opposed to being set on a table top. The rearward surface 26 is vertically orientated such that the cradle body will have a slight downward tilt when mounted to a wall surface to ensure good contact between a video game controller and the video game controller support surface 14. The video game controller support surface 14 may be upwardly turned at a forward end thereof to provide a lip 28 to prevent a video game controller from sliding off the video game controller support surface.

The cradle body 12 includes a display support surface 30 to which is mountable a display 32. The display 32 may provide decorative indicia to the holder 10, which may be selected by the user to his or her individual preferences. The display 30 may be removably mounted permitting a user to change the display as desired. The display 32 may be a static display, such as an ornamental plaque, or may be a changeable electronic display, such as a liquid crystal display (LCD).

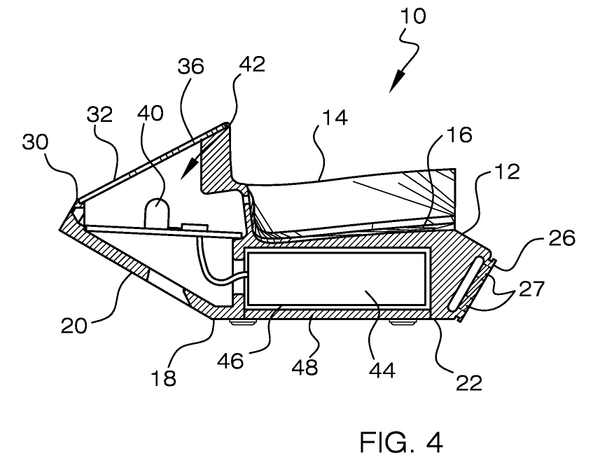

With reference to FIGS. 1 and 4, the display 32 is shown as a static display 36 in the form of an ornamental plaque including ornamental indicia 34. The entire display 36 or only select portions 38 thereof may be light transmissive providing additional decorative affects when the display is illuminated. A light source 40 may be received by the cradle body 12 and positioned such that light is projected from the light source through an opening 42 through the display surface 30 to illuminate the display 36 from the back. A power source, such as a battery pack 44 is connected to the light source 40 to provide power thereto. An on/off switch (not shown) may be provided to operate the light source 40. The battery pack 44 is removably located within an internal battery compartment 46 that is accessible by door 48.

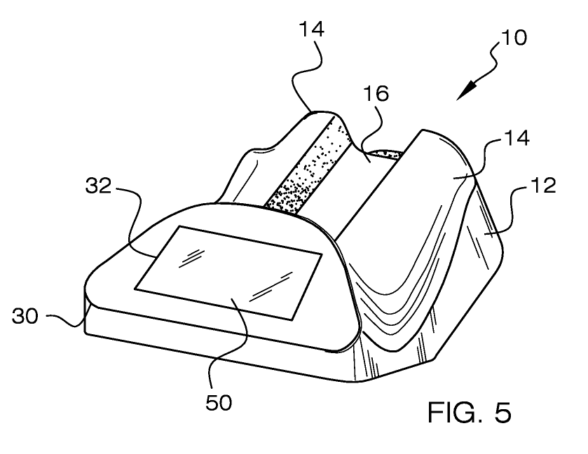

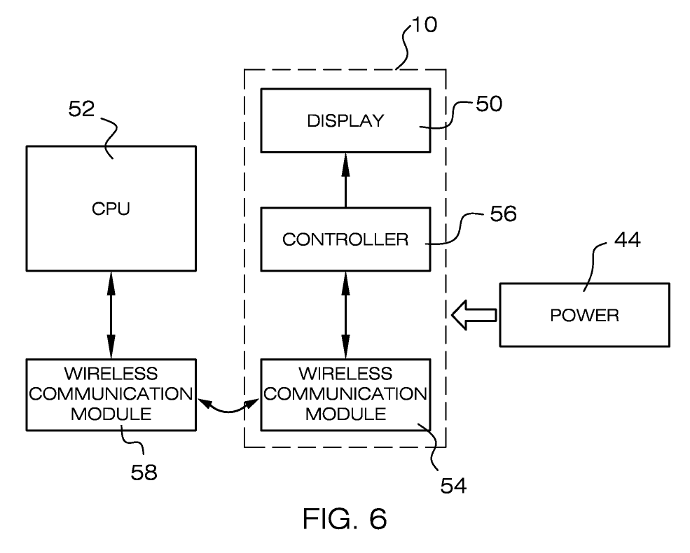

With reference to FIG. 5, the display 32 is shown as an electronic display 50, such as an LCD screen. The electronic display may be pre-programmed with various images or visual effects that are selectable by the user. Alternatively, the electronic display 50 may be operatively connectable to a remote computer or video game console by any data link method available and known to one of ordinary skill in the art to display various information provided to the display by the remote computer or video game console. Such information may include on-line gaming community information, various related announcements, images, video, etc. FIG. 6 illustrates an example wireless data link that may be used to wireless connect the electronic display 50 to a remote computer or video game console comprising a computer processing unit (CPU) 52. In this example, a first wireless communication module 54 is electronically coupled to a controller 56 that operates to drive the electronic display 50. A source of power, such as battery 44, is connected to the wireless communication module 54, controller 56 and the electronic display 50 to provide electrical power for operation. A second wireless communication module 58 is electronically coupled to the CPU 52. The wireless communication modules 54 and 58 provide a wireless data link between the CPU 52 and display controller 56. The wireless communication modules 54 and 58 provide wireless communication using any known transmission methods. Radio frequency, IR, Bluetooth®, wireless lan are only a few examples of such known transmission methods.

A number of embodiments of the present invention have been described. Nevertheless, it will be understood that various modifications may be made without departing from the spirit and scope of the invention. Accordingly, other embodiments are within the scope of the following claims.

What is claimed is:

1. A holder for a video game controller, comprising:
a cradle body defining an upwardly facing video game controller support surface for receiving and holding a video game controller thereon, and a display surface; and
a display attached to said display surface.

2. The holder of claim 1, further comprising:
a light source;
a power source connected to said light source and operable to provide power to said light source to cause said light source to illuminate;
said display including at least one light transmissive portion; and
said light source being positioned to transmit light through said at least one light transmissive portion.

3. The holder of claim 2, wherein said light source is positioned to project light through an opening through said display surface to backlite said display.

4. The holder of claim 1, wherein said video game controller support surface includes a central recessed portion and, a pair of support surfaces along opposite sides of said central recessed portion that are contoured to compliment the exterior surface of a video game controller so as to receive and support a video game controller thereon.

5. The holder of claim 1, wherein said cradle body defines a rearwardly facing mounting surface for facilitating mounting of said cradle body to a support surface.

6. The holder of claim 1, further comprising:
a power source; and
wherein said display is an electronic display, and said power source is connected to said electronic display to provide power thereto.

7. The holder of claim 6, further comprising:
a wireless communication means for connecting said electronic display to a computer processing unit to transmit information from said computer processing unit to be displayed on said electronic display.

8. A holder for a video game controller, comprising:
a cradle body having an upwardly facing video game controller support surface for receiving and holding a video game controller thereon, a display surface, a bottom surface opposite said video game controller support surface, and a rear surface;
said video game controller support surface including a longitudinal central recessed portion and, a pair of longitudinal support surfaces along opposite sides of said central recessed portion that are contoured to compliment the exterior surface of a video game controller so as to receive and support a video game controller thereon; and
a display attached to said display surface.

9. The holder of claim 8, wherein said bottom surface includes a forward portion angled relative to a rearward portion.

10. The holder of claim 8, further comprising:
a light source;
a power source connected to said light source and operable to provide power to said light source to cause said light source to illuminate;
said display including at least one light transmissive portion; and
said light source being positioned to transmit light through said at least one light transmissive portion.

11. The holder of claim 10, wherein said light source is positioned to project light through an opening through said display surface to backlite said display.

12. The holder of claim 8, further comprising:
a power source; and
wherein said display is an electronic display, and said power source is connected to said electronic display to provide power thereto.

13. The holder of claim 12, further comprising:
a wireless communication means for connecting said electronic display to a computer processing unit to transmit information from said computer processing unit to be displayed on said electronic display.
